(19) United States
(12) Patent Application Publication
(10) Pub. No.: US 2015/0220981 A1
(43) Pub. Date: Aug. 6, 2015

(54) PRODUCT PROMOTING SYSTEM

(71) Applicant: TOSHIBA TEC KABUSHIKI KAISHA

(72) Inventors: Tomonori IKUMI, Numazu Shizuoka (JP); Masami TAKAHATA, Setagaya Tokyo (JP); Mika HIRAMA, Kokubunji Tokyo (JP); Naoki WATANABE, Adachi Tokyo (JP)

(21) Appl. No.: 14/608,460

(22) Filed: Jan. 29, 2015

(30) Foreign Application Priority Data
Jan. 31, 2014 (JP) 2014-018020
Aug. 29, 2014 (JP) 2014-176019

(51) Int. Cl. G06Q 30/02

(52) U.S. Cl. CPC G06Q 30/0253; G06Q 30/0268

(57) ABSTRACT

A product promoting system includes a storage unit storing data of one or more recipes, each of the one or more recipes being stored in association with at least one item for sale at a store, an operation unit located at the store and configured to receive a user input that selects a recipe from the one or more recipes, a processing unit configured to determine at least one item for sale at the store associated with the selected recipe, and an output unit configured to generate a first output including the selected recipe and a second output that encodes the at least one item for sale at the store that is determined to be associated with the selected recipe.

### CROSS-REFERENCE TO RELATED APPLICATION

This application is based upon and claims the benefit of priority from Japanese Patent Application No. 2014-018020, filed Jan. 31, 2014 and Japanese Patent Application No. 2014-176019, filed Aug. 29, 2014; the entire contents of both applications are incorporated herein by reference.

### FIELD

Embodiments described herein relate generally to a product prompting system for items for sale at a store.

### BACKGROUND

In a store that sells food items, such as a supermarket, a prepared food is marketed to customers, in order to promote sales of items that are required by the recipe for the prepared food. However, the prepared food marketed to customers may not be the one that the customers prefer. Further, even if the customers in fact decided to cook the prepared food marketed to them and bought the necessary food items, the store cannot precisely quantify the effect of marketing on the sales of the food items.

### DESCRIPTION OF THE DRAWINGS

FIG. 1 is a block diagram of a recipe providing system according to an embodiment.

FIG. 2 is a block diagram of a server in the recipe providing system according to the embodiment.

FIG. 3 illustrates a primary memory region which is formed in a RAM of the server according to the embodiment.

FIG. 4 is a block diagram of a user terminal in the recipe providing system according to the embodiment.

FIG. 5 is a block diagram of a POS terminal in the recipe providing system according to the embodiment.

FIG. 6 illustrates an example of a display screen of the user terminal according to the embodiment.

FIG. 7 illustrates an example of a recipe selection screen according to the embodiment.

FIG. 8 illustrates an example of a recipe printing screen according to the embodiment.

FIG. 9 illustrates an example of a recipe sheet according to the embodiment.

FIG. 10 illustrates another example of the recipe sheet according to the embodiment.

FIG. 11 is a block diagram illustrating an operation in which the recipe providing system according to the embodiment receives the recipe selection.

FIG. 12 is a block diagram illustrating an operation in which the recipe providing system according to the embodiment prints the recipe.

FIG. 13 is a flowchart illustrating an operation carried out by the user terminal according to the embodiment.

FIG. 14 is a flowchart illustrating an operation carried out by the POS terminal according to the embodiment.

### DETAILED DESCRIPTION

The embodiments provide a recipe providing system, a recipe providing method, and a recipe providing program which may efficiently manage distribution of a recipe and sales of merchandise.

In general, according to one embodiment, a product promoting system includes a storage unit storing data of one or more recipes, each of the one or more recipes being stored in association with at least one item for sale at a store, an operation unit located at the store and configured to receive a user input that selects a recipe from the one or more recipes, a processing unit configured to determine at least one item for sale at the store associated with the selected recipe, and an output unit configured to generate a first output including the selected recipe and a second output that encodes the at least one item for sale at the store that is determined to be associated with the selected recipe.

Hereinafter, the embodiments will be described with reference to the drawings. First, a configuration of a recipe providing system will be described.

The recipe providing system according to an embodiment prints a recipe based on an instruction of a user. The recipe providing system is installed in a grocery store such as a super market. A customer who comes to the grocery store such as the super market selects the recipe from a plurality of recipes which are displayed on a display unit of the recipe providing system, and may print the selected recipe. In a sheet (recipe sheet) on which the recipe is printed, coupon information is written. The user presents the sheet on which the recipe is printed, to a salesperson at a cash register or the like, and may receive a service based on the coupon information.

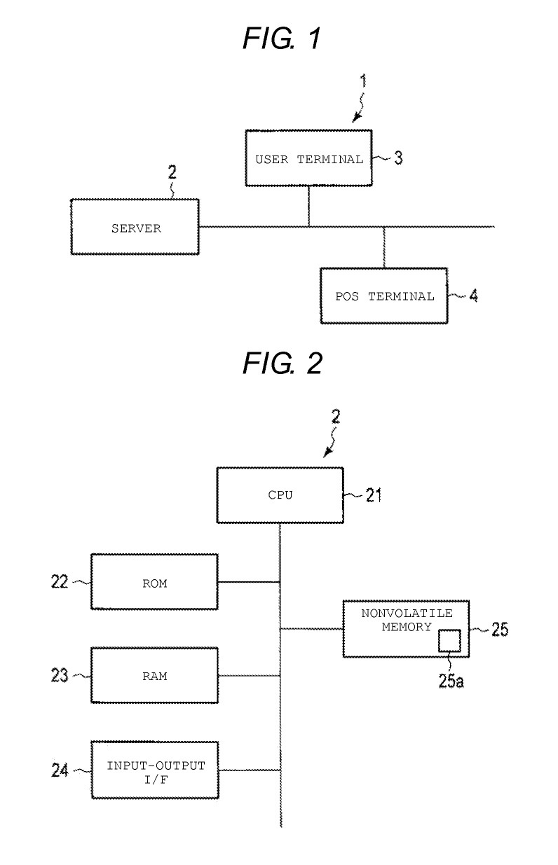

FIG. 1 is a block diagram of a recipe providing system 1.

As illustrated in FIG. 1, the recipe providing system 1 includes a server 2, a user terminal 3, a POS terminal 4, and the like.

The server 2 collectively handles the whole of the recipe providing system 1. For example, the server 2 transmits the recipe data to the user terminal 3, or receives operational information from the user terminal 3 and the POS terminal 4. Moreover, the server 2 manages the number of times the recipe is selected by the user at the user terminal 3, the number of times the recipe is printed by the user terminal 3, and the like. Furthermore, the server 2 manages the data of the purchased items through the POS terminal 4, and the like. The server 2 may be located within a grocery store such as the super market, or may be located outside thereof.

The user terminal 3 displays the recipe, based on the instruction from the server 2 or the user. Additionally, the user terminal 3 prints the recipe based on the recipe selection by the user. The user terminal 3 displays one or more recipes and proposes the user to select one. Moreover, the user terminal 3 receives a user operation for printing the selected recipe. For example, the user terminal 3 is located at a place where the customers of the grocery store may conveniently use the user terminal 3, such as an entrance of the grocery store such as the super market.

The POS terminal 4 performs checkout processing of items for sale. Moreover, the POS terminal 4 transmits information indicating that items for sale corresponding to the recipe sheet carried by the customer (user) is purchased, to the server 2. For example, the POS terminal 4 may be located at a place where the salesperson performs the checkout processing of the items, such as a checkout lane of the grocery store. Additionally, the POS terminal 4 may perform the checkout processing by the operation of the customer of the grocery store.

The server 2 is electrically connected to the user terminal 3 and the POS terminal 4, in a wired or a wireless manner. The server 2 may transmit data to and receive data from the user terminal 3 and the POS terminal 4. For example, when the server 2 is located inside the grocery store, the server 2 may be connected to the user terminal 3 and the POS terminal 4, through a wired or a wireless LAN. Moreover, when the server 2 is located outside the grocery store, the server 2 may be connected to the user terminal 3 and the POS terminal 4 through a communication network such as the Internet.

FIG. 2 is a block diagram of the server 2.

As illustrated in FIG. 2, the server 2 has a CPU 21, a ROM 22, a RAM 23, an input-output interface (I/F) 24, a nonvolatile memory 25, and the like.

The CPU 21 controls the entire server 2. The CPU 21 is a processor which carries out various kinds of processing by executing a program. The CPU 21 is connected to each unit within the server 2, through a system bus or the like. Depending on an operational instruction from an external apparatus, The CPU 21 outputs an operational instruction to each unit within the server 2, or notifies various kinds of information which is obtained from each unit to the external apparatus. For example, the CPU 21 transmits the recipe data to the user terminal 3 through the input-output I/F 24. Additionally, the CPU 21 receives the information about the purchased item from the POS terminal 4, and manages the information.

The ROM 22 is a nonvolatile memory that stores the program, control data or the like, and is non-rewritable.

The RAM 23 is a volatile memory. The RAM 23 is a working memory or a buffer memory. The CPU 21 carries out various kinds of processing by executing the program which is stored in the ROM 22 while using the RAM 23.

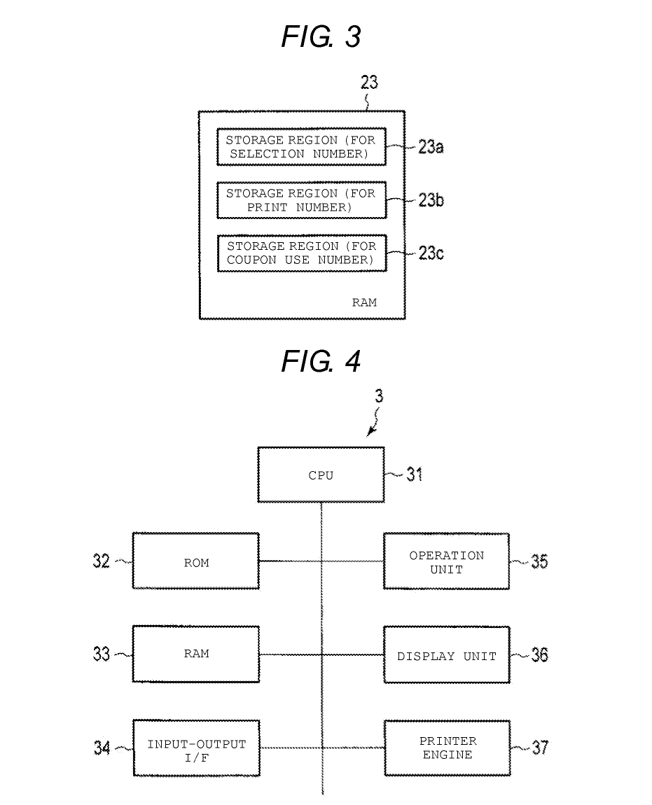

As illustrated in FIG. 3, the RAM 23 has a storage region 23a to 23c. Data stored in the storage regions 23a to 23c, will be described below in detail.

The input-output I/F 24 is an interface for communicating with the user terminal 3 and the POS terminal 4. Based on an order from the CPU 21, the input-output I/F 24 transmits various types of data to the user terminal 3 and the POS terminal 4. Moreover, the input-output I/F 24 receives various kinds of data from the user terminal 3 and the POS terminal 4. For example, the input-output I/F 24 may be an interface that is locally connected to the user terminal 3 and the POS terminal 4, or may be an interface for communicating with the user terminal 3 and the POS terminal 4 through the communication network such as the Internet.

For example, the nonvolatile memory 25 is a nonvolatile memory in which data may be written and rewritten, such as an EEPROM, a flash ROM, an HDD (hard disk drive), or SSD (Solid State Disk). The nonvolatile memory 25 stores a control program, the control data, and various data, depending on an intended use of the server 2.

Moreover, the nonvolatile memory 25 has a storage region 25a which stores the recipe data. The storage region 25a may store data of a plurality of recipes. The number of the recipes stored in the storage region 25a is not limited to a specific number.

The recipe data includes information of a recipe relating to a specific dish. One or more items for sale in the store are used for the specific dish. Furthermore, the partial ingredient of the dish or all ingredients of the dish may be the items for sale in the store.

For example, the recipe data includes a photograph of the dish, the ingredients of the dish, a procedure to cook the dish, time necessary to cook the dish, calories of the dish, and the like. Information included in the recipe data is not limited.

The storage region 25a stores the recipe data in advance. For example, a person may operate the server 2 to store the recipe data in the storage region 25a in advance. Moreover, the storage region 25a may update the recipe data by adding new recipe data. Furthermore, the unnecessary recipe data may be removed from the storage region 25a.

Furthermore, in the server 2, the operation unit such as a keyboard, or the display unit such as a display, may be disposed.

FIG. 3 illustrates primary storage regions formed in the RAM 23 of the server 2.

The storage region 23a stores a selection number. The selection number is the number of times the recipe data is selected by customers. The storage region 23a stores the selection number per recipe. When the storage region 25a of the nonvolatile memory 25 stores data for the plurality of recipes, the storage region 23a stores the selection number with respect to each of the recipes.

The storage region 23b stores a printing number. The printing number is the number of times the recipe data is printed by the user terminal 3. The storage region 23b stores the printing number per recipe. When the storage region 25a of the nonvolatile memory 25 stores data for the plurality of recipes, the storage region 23b stores the printing number with respect to each of the recipes.

The storage region 23c stores a coupon use number. The coupon use number is the number of times the coupon attached to the recipe is used by the customers. The storage region 23c stores the coupon use number per recipe. When the storage region 25a of the nonvolatile memory 25 stores data for the plurality of recipes, the storage region 23c stores the coupon use number with respect to each of the recipes. For example, the coupon is for a predetermined food used in the dish. That is, the coupon use number is the number of times a target item (food ingredient) corresponding to the recipe is used by the customers carrying the recipe sheets. The target item is at least an item used in the dish of the recipe. Additionally, the storage region 23c may store the coupon use number in correlation with the number of times the recipe is printed.

Furthermore, the nonvolatile memory 25 may include the storage regions 23a to 23c.

FIG. 4 is a block diagram of the user terminal 3.

As illustrated in FIG. 4, the user terminal 3 has a CPU 31, a ROM 32, a RAM 33, an input-output interface (I/F) 34, an operation unit 35, a display unit 36, a printer engine 37, and the like.

The CPU 31 controls the entire user terminal 3. The CPU 31 is a processor which carries out various kinds of processing by executing the program. The CPU 31 is connected to each unit of the user terminal 3, through the system bus or the like. Depending on the operational instruction from an external apparatus, the CPU 31 outputs the operational instruction to each unit within the user terminal 3, or notifies various kinds of information which is obtained from each unit to the external apparatus. For example, the CPU 31 receives the recipe data from the server 2 through the input-output I/F 34, and displays the received recipe data on the display unit 36. Moreover, the CPU 31 controls the printer engine 37 to print the recipe indicated by the recipe data. In Addition, the CPU 31 transmits information indicating that the user selects the recipe, and information indicating that the user prints the recipe, to the server 2 through the input-output I/F 34.

The ROM 32 is a nonvolatile memory that stores the program, the control data or the like, and is non-rewritable.

The RAM 33 includes a volatile memory. The RAM 33 is a working memory or a buffer memory. The CPU 31 carries out various kinds of processing by executing the program stored in the ROM 32 while using the RAM 33.

The input-output I/F 34 is an interface for communicating with the server 2 or the like. Based on the order from the CPU 31, the input-output I/F 34 transmits various kinds of data to the server 2. Moreover, the input-output I/F 34 receives various kinds of data from the server 2. For example, the input-output I/F 34 may be an interface that is locally connected to the server 2, or may be an interface for communicating with the server 2 through the communication network such as the Internet.

The operation unit 35 receives various operational inputs by the user. The operation unit 35 receives a selection operation for selecting the recipe. The operation unit 35 receives a print operation for printing the recipe. The operation unit 35 transmits the received operation to the CPU 31. For example, the operation unit 35 is a keyboard, a mouse, or the like.

The display unit 36 displays various kinds of information to the user of the user terminal 3. For example, based on the instruction of the CPU 31, the display unit 36 displays the recipe. Moreover, the display unit 36 displays an image for receiving an input of the selection instruction or the printing instruction of the recipe. For example, the display unit 36 is a liquid crystal display.

Furthermore, the operation unit 35 and the display unit 36 may be integrally configured as a touch panel display, or the like.

The printer engine 37 prints the recipe based on the instruction of the CPU 31. That is, if the operation unit 35 receives the printing operation, the printer engine 37 prints an image for printing which includes the recipe, on the sheet. The image for printing may be generated by the CPU 31 based on the recipe data, or may be received from the server 2. Moreover, based on the instruction of the CPU 31, the printer engine 37 may print specific information related to the recipe on the sheet. The specific information will be described below. The printer engine 37 may include a sheet supply unit, a sheet transfer unit, a typing unit, or the like.

A printing method of the printer engine 37 is not limited to a specific method, and any method including an ink jet method or an electrophotographic method can be used.

The user terminal 3 may further include the nonvolatile memory, or the like.

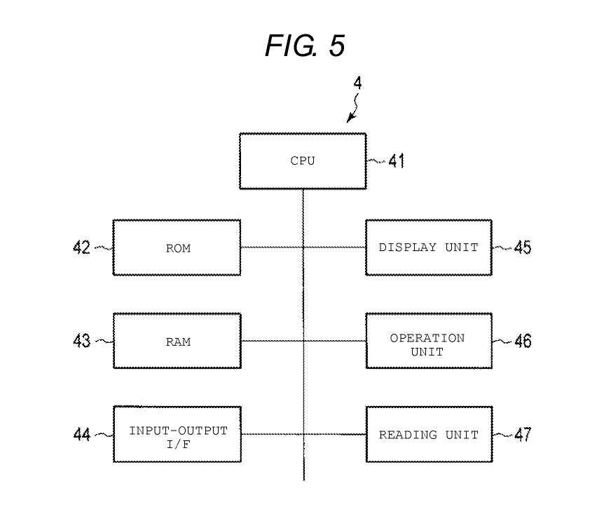

FIG. 5 is a block diagram of the POS terminal 4.

As illustrated in FIG. 5, the POS terminal 4 has a CPU 41, a ROM 42, a RAM 43, an input-output interface (I/F) 44, an operation unit 45, a display unit 46, a reading unit 47, and the like.

The CPU 41 controls the entire POS terminal 4. The CPU 41 is a processor which carries out various kinds of processing by executing the program. The CPU 41 is connected to each unit of the POS terminal 4, through the system bus or the like. Depending on the operational instruction from an external apparatus, the CPU 41 outputs the operational instruction to each unit of the POS terminal 4, or notifies various kinds of information obtained from each unit to the external apparatus. For example, the CPU 41 receives information indicating a discount rate or the like of the coupon from the server 2 through the input-output I/F 44. Moreover, the CPU 41 performs the checkout processing of the item which the user is going to purchase, based on the received information. Additionally, the CPU 41 transmits information indicating the item which is purchased by the user and the coupon, to the server 2 through the input-output I/F 44.

The ROM 42 is a nonvolatile memory that stores the program, the control data or the like, and is non-rewritable.

The RAM 43 includes a volatile memory. The RAM 43 is a working memory or a buffer memory. The CPU 41 carries out various kinds processing by executing the program stored in the ROM 42 while using the RAM 43.

The input-output I/F 44 is an interface for communicating with the server 2 or the like. Based on the order from the CPU 41, the input-output I/F 44 transmits various kinds of data to the server 2. Moreover, the input-output I/F 44 receives various kinds of data from the server 2. For example, the input-output I/F 44 may be an interface that is locally connected to the server 2, or may be an interface for communicating with the server 2 through the communication network such as the Internet.

The operation unit 45 receives various operational inputs by the salesperson. For example, the operation unit 45 receives the input of information which is necessary for the checkout processing by operation of the salesperson. The operation unit 45 transmits the received operation to the CPU 41. For example, the operation unit 45 is the keyboard, the mouse, or the like.

The display unit 46 displays various kinds of information to the salesperson who operates the POS terminal 4. Moreover, the display unit 46 may display various kinds of information to the user. For example, based on the instruction of the CPU 41, the display unit 46 displays a price of the item to be purchased, a total price, or the like. Moreover, the display unit 46 may display an image for receiving the input of the operation of the salesperson. For example, the display unit 46 is a liquid crystal display.

Furthermore, the operation unit 45 and the display unit 46 may be integrally configured as a touch panel display, or the like.

The reading unit 47 reads the specific information from the sheet on which the recipe is printed. When the specific information is indicated by a barcode, the reading unit 47 is a barcode reader. Moreover, when the specific information is provided to the recipe sheet using a radio tag (RFID tag), the reading unit 47 may be a short distance radio communication apparatus, or the like. The reading unit 47 may be a handy type, or may be fixed to the POS terminal 4. Additionally, the reading unit 47 may read the information specifying the item for sale, such as a barcode associated with the item.

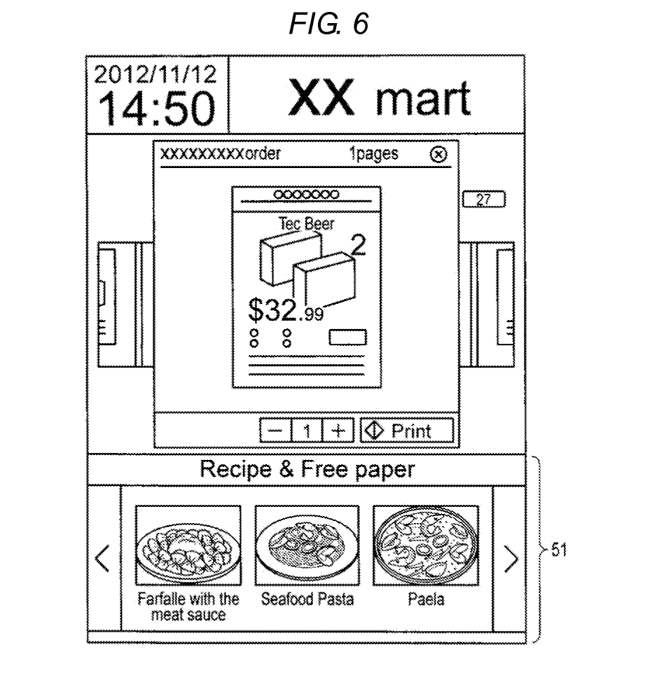

Next, a screen which is displayed by the display unit 36 of the user terminal 3 will be described. FIG. 6 illustrates an example of an initial screen which is displayed by the user terminal 3. The initial screen is displayed by the user terminal 3 first. As illustrated in FIG. 6, the initial screen indicates various kinds of information relating to the grocery store where the user terminal 3 is located.

The initial screen displays an icon to display a recipe selection screen. A display region 51 displays the icon to display the recipe selection screen. If the user touches the icon, the user terminal 3 transitions to the recipe selection screen. Furthermore, the display region 51 may display an icon to display a printing screen of a specific recipe.

The initial screen may further display an icon to display the coupon information, an icon to display a map, or the like. The initial screen is not limited to a specific configuration.

Next, the recipe selection screen will be described.

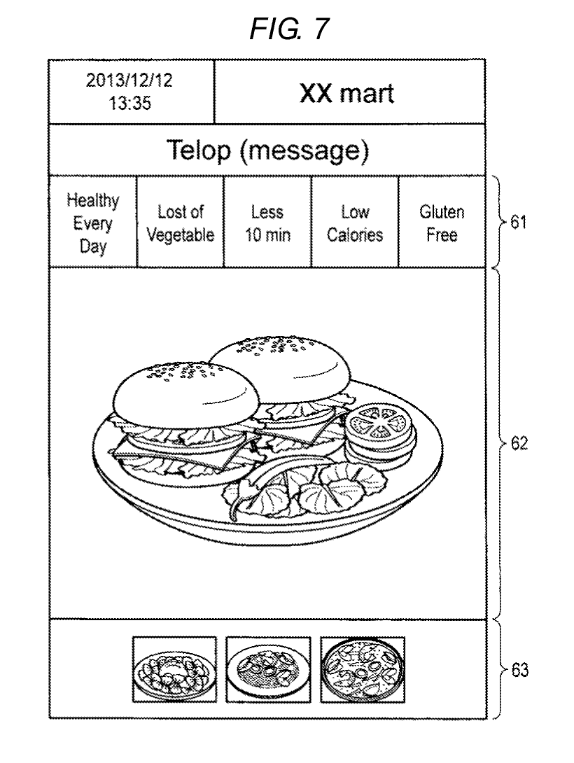

FIG. 7 illustrates an example of the recipe selection screen which is displayed on the user terminal 3. The recipe selection screen is a screen through which the user selects a recipe. Here, the recipe selection screen displays a plurality of selection icons with which the user can select the recipe. The user selects the recipe by touching one of the selection icons. As illustrated in FIG. 7, the recipe selection screen includes a display region 61, a display region 62, and a display region 63.

The display region 61 displays a plurality of category icons indicating categories of dishes, as the selection icons. The display region 61 displays icons to select one of the categories such as a healthy dish, a dish with many vegetables, a dish which may be cooked in 10 minutes or less, a dish of low calories, or a gluten-free dish. The user can select the dishes corresponding to the category which is indicated by the category icon, by touching the category icon.

The categories displayed in the display region 61, is not limited to specific categories.

The display region 62 displays a dish icon indicating the image of the dish, as the selection icon. The display region 62 updates the dish icon every fixed period. That is, every fixed period, the display region 62 displays the images of different dishes, as the dish icon. If all of the dish icons are displayed, then the display region 62 displays the dish icon displayed first. The user can view the recipe for the dish, by touching the dish icon.

The display region 63 displays a plurality of dish icons which may be selected, as the selection icons. The dish icons displayed in the display region 63 are fixed, differently from the display region 62. The user can view a recipe for a dish corresponding to the dish icon, by touching the dish icon.

Furthermore, the dish icon may include a name of the dish and the calories of the dish, in addition to the image of the dish. The dish icon is not limited to specific icons.

In the recipe selection screen, the display region may not be divided into three. The configuration of the recipe selection screen is not limited to the specific configuration.

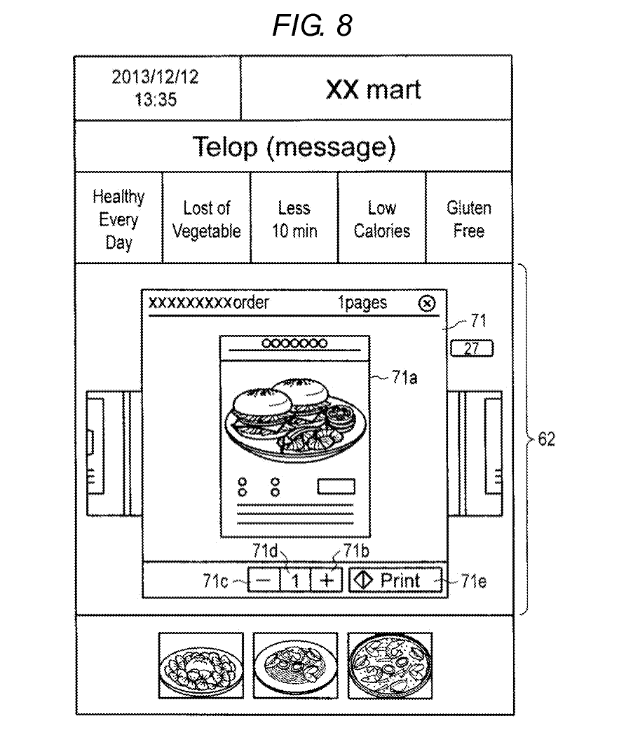

Next, a recipe printing screen will be described. FIG. 8 illustrates an example of the recipe printing screen.

The recipe printing screen is a screen to print the recipe selected by the user. As illustrated in FIG. 8, a recipe printing screen 71 is displayed inside the display region 62. The recipe printing screen 71 includes a print image 71a, an addition icon 71b, a reduction icon 71c, a print number icon 71d, and a print icon 71e.

The print image 71a is an image which is to be printed on the sheet. For example, the print image 71a is a photograph of the dish, ingredients of the dish, and a position in a store where the ingredient is located. The print image 71a is not limited to a specific image. The print image 71a may be generated by the CPU 31 based on the recipe data. Moreover, the print image 71a may be transmitted from the server 2.

The addition icon 71b is an icon to add the print number. The user may add the print number of the print image 71a by one, by touching the addition icon 71b.

The reduction icon 71c is an icon to reduce the print number. The user may reduce the print number of the print image 71a by one, by touching the reduction icon 71c.

The print copy number icon 71d indicates the print number of the print image 71a. In an initial state, the print number icon 71d may indicate “1,” as the print number.

The print icon 71e is an icon to instruct the printing of the printing image 71a. If the user touches the print icon 71e, the user terminal 3 prints the print image 71a of the print number indicated by the print copy number icon 71d.

The recipe printing screen 71 is not limited to a specific screen. Moreover, the recipe printing screen 71 may be displayed in the entire region of the display unit 36 of the user terminal 3.

Next, the recipe sheet that the recipe providing system 1 prints will be described.

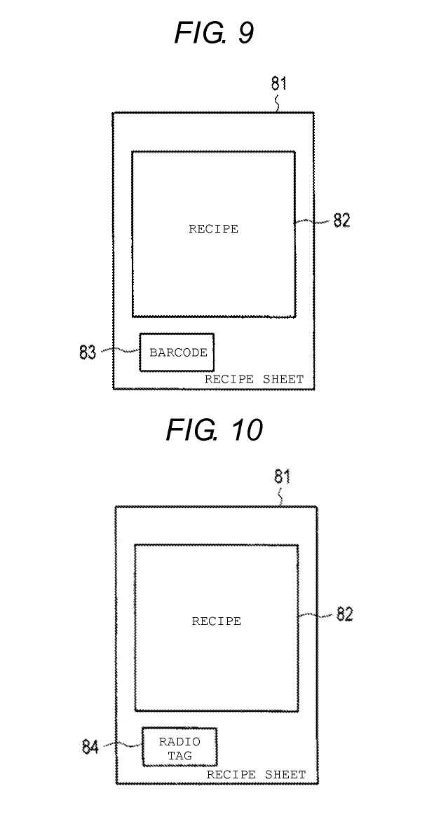

FIG. 9 illustrates an example of a recipe sheet 81 on which the recipe providing system 1 prints. As illustrated in FIG. 9, the recipe sheet 81 includes a printing region 82 and a printing region 83.

The printing region 82 is a region where the recipe is printed. That is, in the printing region 82, the print image 71a is printed.

The printing region 83 is a region where the specific information. The specific information includes information which indicates food corresponding to the recipe. For example, the specific information may be coupon information of an item for sale associated with the recipe. The item for sale indicated by the specific information includes the food ingredient listed in the recipe. The coupon information is information of discount or point addition. The specific information may be identification information of the recipe. For example, the identification information may be an ID code of the recipe data. In this case, the POS terminal 4 stores information indicating the items for sale associated with the recipe in advance, and thereby, the items associated with the recipe of the recipe sheet which is carried by the user, may be identified.

The specific information is printed as a form which can be read by the reading unit 47 of the POS terminal 4. For example, the specific information is printed as a barcode or a two-dimensional code, within the printing region 83. The printing form of the specific information is not limited to a specific form.

FIG. 10 illustrates another example of the recipe sheet 81 that the recipe providing system 1 prints.

The recipe sheet 81 illustrated in FIG. 10, is different from the recipe sheet 81 illustrated in FIG. 9, in that the printing region 83 is replaced with a radio tag 84.

The radio tag 84 is a tag which receives data from and transmits data to the external apparatus by wireless communication. The power is wirelessly supplied to the radio tag 84 from the external apparatus, and the radio tag 84 is activated. The radio tag 84 receives a read command or the like from the external apparatus, and thereby, transmits the internal data to the external apparatus. The radio tag 84 is a wireless apparatus in which the reading unit 47 may read the data. For example, the radio tag 84 includes a control unit, an antenna, and a nonvolatile memory.

The radio tag 84 stores the specific information. The radio tag 84 may be embedded in the sheet in advance. Alternatively, the radio tag 84 may be embedded in a seal and stored in the user terminal 3. When the radio tag 84 is embedded in the seal, the user terminal 3 attaches the seal including the radio tag 84 to the recipe sheet, after printing the recipe.

For example, the CPU 31 of the user terminal 3 may transmit information indicating the printed recipe to the server 2, in correlation with the ID of the radio tag of the printed sheet on which the recipe is printed. The server 2 may transmit the information indicating the printed recipe to the POS terminal 4, in correlation with the ID of the radio tag of the printed sheet on which the recipe is printed.

The manner in which the specific information is accompanied by the recipe sheet is not limited to a specific manner.

Next, an operational example in which the recipe providing system 1 receives the recipe selection will be described. FIG. 11 is a block diagram illustrating an operation in which the recipe providing system 1 receives the recipe selection. Here, the nonvolatile memory 25 of the server 2 is assumed to store the recipe data in advance.

First, the CPU 21 of the server 2 transmits the recipe data which is stored in the nonvolatile memory 25 to the user terminal 3 through the input-output I/F 24.

The CPU 31 of the user terminal 3 receives the recipe data through the input-output I/F 34. If the recipe data is received, the user terminal 3 becomes usable. If the user terminal 3 is usable, the CPU 31 controls the display unit 36 to display the initial screen. Here, the user operates the recipe selection screen to be displayed, by touching a predetermined icon.

The CPU 31 controls the display unit 36 to display the recipe selection screen. If the recipe selection screen is displayed, the CPU 31 waits until the selection of the recipe is input through the operation unit 35.

If the selection of the recipe is input through the operation unit 35, the CPU 31 controls the display unit 36 to display the recipe printing screen corresponding to the selected recipe. If the recipe printing screen is displayed, the CPU 31 transmits information indicating the selected recipe to the server 2 through the input-output I/F 34.

The CPU 21 of the server 2 receives the information indicating the selected recipe through the input-output I/F 24. If the information is received, in the storage region 23a, the CPU 21 increments the selection number of the corresponding recipe indicated by the received information. If the CPU 21 increments the selection number, the recipe providing system 1 ends the operation for receiving the recipe selection.

Furthermore, the CPU 31 may display the recipe selection screen, after transmitting the information indicating the selected recipe to the server 2. Moreover, the CPU 31 may receive the recipe data from the server 2, after receiving the recipe selection. Additionally, the CPU 31 counts the number of times the recipe has been selected during a fixed period, and may transmit the recipe data to the server 2, in correlation with the number of times the recipe has been selected, after the fixed period.

Next, an operational example in which the recipe providing system 1 prints the recipe, will be described.

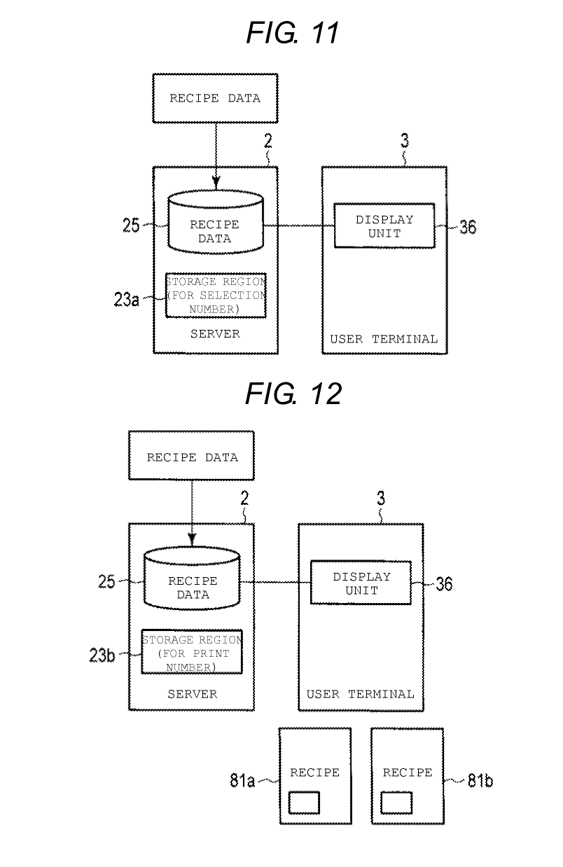

FIG. 12 is a block diagram illustrating an operation in which the recipe providing system 1 prints the recipe.

Here, the user terminal 3 is assumed to display the recipe printing screen, on the display unit 36.

First, the CPU 31 waits until the print icon 71e is touched on the operation unit 35.

If the print icon 71e is touched, the CPU 31 controls the printer engine 37 to print the print image corresponding to the selected recipe.

Moreover, the CPU 31 causes the specific information to be added the recipe sheet on which the print image is printed. When the specific information is printed as the barcode, the CPU 31 prints the barcode indicating the specific information on the sheet. When the specific information is provided using the radio tag, the CPU 31 may transmit the ID of the radio tag to the server 2, in association with the recipe data.

When the print image is printed, the CPU 31 transmits information indicating the printed recipe to the server 2 through the input-output I/F 34.

The CPU 21 of the server 2 receives the information indicating the printed recipe through the input-output I/F 24. If the information is received, in the storage region 23b, the CPU 21 increments the print number of the corresponding recipe which is indicated by the received information. If the CPU 21 increments the print number, the recipe providing system 1 ends the operation for printing the recipe.

Furthermore, the CPU 31 may print the recipe, after transmitting the information indicating the printed recipe to the server 2. Moreover, the CPU 31 counts the number of times the recipe has been printed during a fixed period, and may transmit the recipe to the server 2, in association with the number of times the recipe has been printed, after the fixed period.

Next, an operational example of the user terminal 3 will be described.

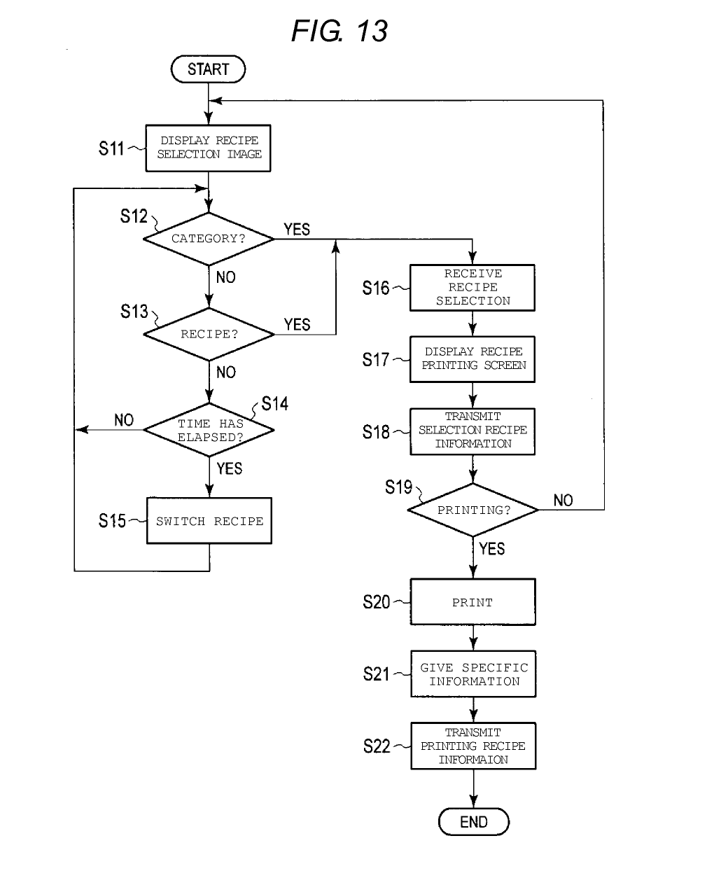

FIG. 13 is a flowchart illustrating an operation carried out by the user terminal 3.

Here, the user touches the icon to display the recipe selection screen, and the user terminal 3 is assumed to display the recipe selection screen.

First, the CPU 31 of the user terminal 3 controls the display unit 36 to display the recipe selection screen (step S11). If the recipe selection screen is displayed, the CPU 31 determines whether one of the category icons is touched on the operation unit 35 (step S12).

If it is determined that one of the category icons is not touched (step S12, NO), the CPU 31 determines whether an image icon is touched on the operation unit 35 (step S13).

If it is determined that the image icon is not touched (step S13, NO), the CPU 31 determines whether a predetermined time has elapsed since the image icon is displayed in the display region 62 (step S14).

If it is determined that the predetermined time has elapsed since the image icon is displayed in the display region 62 (step S14, YES), the CPU 31 switches the image icon displayed in the display region 62 (step S15).

When it is determined that the predetermined time has not elapsed since the image icon is displayed in the display region 62 (step S14, NO), or when the image icon is switched (step S15), the CPU 31 returns to the step S12.

When it is determined that the category icon is touched (step S12, YES), or when it is determined that the image icon is touched (step S13, YES), the CPU 31 receives the selection of the recipe which is associated with the selected icon (step S16).

If the selection of the recipe is received, the CPU 31 controls the display unit 36 to display the recipe printing screen (step S17). If the recipe printing screen is displayed, the CPU 31 transmits the selection recipe information indicating the selected recipe to the server 2 through the input-output I/F 34 (step S18).

If the selection recipe information is transmitted to the server 2, the CPU 31 determines whether the print icon 71e is touched (step S19). If it is determined that the print icon 71e is touched (step S19, YES), the CPU 31 controls the printer engine 37 to print the recipe on the sheet (step S20). If the recipe is printed on the sheet, the CPU 31 operates to attach the specific information to the recipe sheet (step S21).

If the recipe is printed on the sheet, the CPU 31 transmits the printing recipe information indicating the printed recipe to the server 2 through the input-output I/F 34 (step S22).

If the printing recipe information is transmitted to the server 2, the CPU 31 ends the operation.

If it is determined that the print icon 71e is not touched (step S19, NO), the CPU 31 returns to the step S11. Furthermore, if the print icon 71e is not touched for a fixed period, the CPU 31 may return to the step S11. Moreover, when it is determined that an icon returning to the recipe selection screen is touched, the CPU 31 may return to the step S11.

Next, an operational example of the checkout processing in the recipe providing system 1 will be described.

Here, the specific information is assumed to include the coupon information.

First, the salesperson of the grocery store, receives items to be purchased and the recipe sheet from the user (customer). The salesperson operates the reading unit 47 of the POS terminal 4 to read the barcode attached to the items, and the specific information attached to the recipe sheet.

Based on the coupon information which is included in the specific information, the POS terminal 4 determines whether the coupon target item, which is a target of the coupon, is included in the items to be purchased. If it is determined that the coupon target item is included in the items to be purchased, the POS terminal 4 transmits information indicating that the coupon has been used, to the server 2 (that is, information indicating that the item indicated by the specific information has been purchased).

The CPU 21 of the server 2 receives the information indicating that the coupon has been used. If the information is received, in the storage region 23c, the CPU 21 increments the coupon use number of the corresponding coupon which is indicated in the received information.

Moreover, the POS terminal 4 performs the checkout processing of the items, based on the barcode which is attached to the item to be purchased, and the coupon information included in the specific information attached to the recipe sheet.

If the POS terminal 4 performs the checkout processing of the items, the recipe providing system 1 ends the operation.

Next, an operational example of the POS terminal 4 will be described.

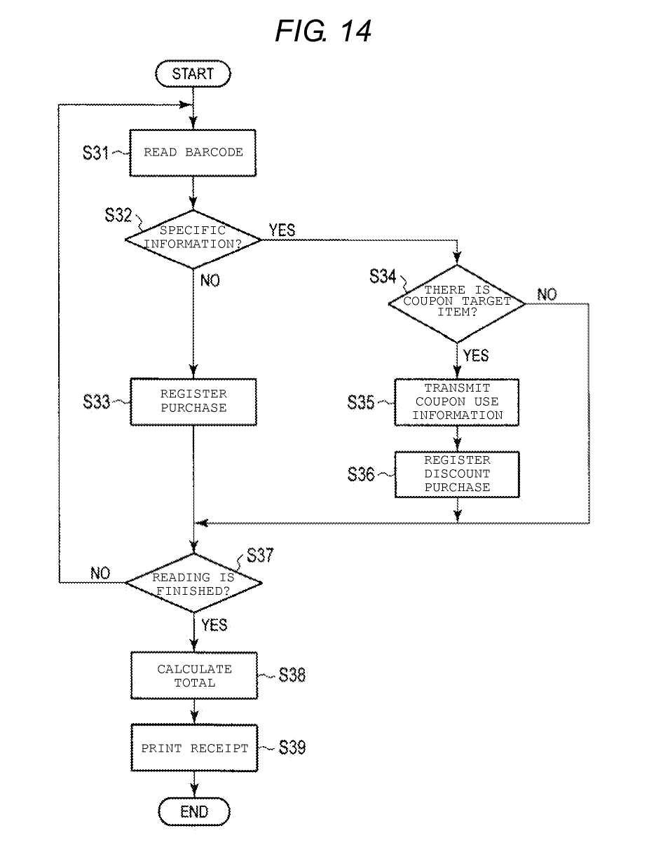

FIG. 14 is a flowchart illustrating an operation carried out by the POS terminal 4.

Here, the specific information is assumed to be printed as a barcode. Moreover, the salesperson operates the reading unit 47 to read the barcode of the item to be purchased first, and then the barcode as the specific information.

First, the CPU 41 of the POS terminal 4 controls the reading unit 47 to read the barcode (step S31). At the same time, the salesperson or the like brings the barcode close to the reading unit 47 to be read.

If the barcode is read, the CPU 41 determines whether the read barcode is a barcode indicating the specific information (step S32).

If it is determined that the read barcode does not indicate the specific information (step S32, NO), the CPU 41 registers the item which is indicated by the barcode, as an item to be purchased (step S33).

If it is determined that the read barcode indicates the specific information (step S32, YES), the CPU 41 determines whether there is a coupon target item in the items registered as the items to be purchased (step S34).

If it is determined that there is the coupon target item in the items registered as the items to be purchased (step S34, YES), the CPU 41 transmits coupon use information indicating that the coupon indicated by the specific information has been used, to the server 2 through the input-output I/F 44 (step S35).

If the coupon use information is transmitted to the server 2, the CPU 41 registers a predetermined discount or the like regarding the coupon target item (step S36).

When the item indicated by the barcode is registered as the item to be purchased (step S33), when it is determined that there is no coupon target item in the items registered as the item to be purchased (step S34, NO), or when the predetermined discount or the like regarding the coupon target item is registered (step S36), the CPU 41 determines whether the reading of the barcode is ended (step S37). For example, the CPU 41 determines whether the salesperson or the like inputs that the readings of all barcodes are ended.

When it is determined that the reading of the barcode is not ended (step S37, NO), the CPU 41 returns to the step S31.

When it is determined that the reading of the barcode is ended (step S37, YES), the CPU 41 calculates the total price of the items to be purchased (step S38). If the total price is calculated, the CPU 41 prints a recipe (step S39). If the recipe is printed, the CPU 41 ends the operation.

Here, the coupon information may be related to a plurality of items for sale. In this case, the coupon use number may be incremented with respect to each of the items.

Moreover, the POS terminal 4 increments the number of times the coupon has been used during the fixed period, and may transmit the number of times to the server 2, after the fixed period.

Additionally, when the specific information is provided using the radio tag, the POS terminal 4 may transmit the ID of the radio tag to the server 2, in association with the information indicating the item purchased by the user. Furthermore, the POS terminal 4 may obtain the recipe data which is correlated with the ID of the radio tag from the server 2 in advance, and may determine whether the target item is included in the purchased items.

Moreover, the server 2, the user terminal 3, and the POS terminal 4 may be one apparatus. The server 2 and the user terminal 3 may be one apparatus. Alternatively, the server 2 and the POS terminal 4 may be one apparatus. Alternatively, the user terminal 3 and the POS terminal 4 may be one apparatus.

Moreover, the recipe providing system may be carried out by executing the program by a computer. In this case, the program causes the computer to achieve the above functions. The configuration of confirming whether the recipe printing of the user is tied to the purchase of the item, is summarized as follows. That is, the recipe providing system includes a first storage unit that stores printing information including the target merchandise within the store, an operation unit that receives an operation for printing the printing information stored in the first storage unit, a printing unit that prints the printing information on the sheet, based on the operation which is received by the operation unit, a reading unit that reads the information indicating the target merchandise from the sheet, a determination unit that determines whether the user purchases the target merchandise, based on the target merchandise read by the reading unit, and merchandise information indicating the merchandise which is purchased by the user, and a second storage unit that stores the number of times of purchasing the target merchandise when the determination unit determines that the user purchases the target merchandise.

More specifically, the recipe providing system may include a third storage unit that stores the number of times of printing the printing information when the printing unit prints the printing information, and the second storage unit may be controlled so as to store the number of times of purchasing the target merchandise, in correlation with the number of times of printing the printing information which is stored in the third storage unit.

The recipe providing system which is configured as described above, can manage the selection number when the user selects the recipe, the printing number when the user prints the recipe, and the number of times the item associated with the recipe has been purchased by the users. Therefore, the recipe providing system may effectively manage the distribution of the recipe and the sales of merchandise in the store. Further, the store can more precisely recognize how much the distribution of the recipe contributes to the sale of the item associated with the recipe.

The embodiments are described using a case where the functions for carrying out the embodiments are recorded on the inside of the apparatus in advance, but are not limited thereto. The same functions may be downloaded in the apparatus from the network, or the same functions are stored in a recording medium, and thereby it may be installed in the apparatus. As a recording medium, if the recording medium may store the program, and are readable by the apparatus, the form thereof may be any form, similarly to a CD-ROM. Moreover, the function which is obtained by installing or downloading in advance as described above, may be realized in cooperation with an OS (operating system) on the inside of the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A product promoting system, comprising:
a storage unit storing data of one or more recipes, each of the one or more recipes being stored in association with at least one item for sale at a store;
an operation unit located at the store and configured to receive a user input that selects a recipe from the one or more recipes;
a processing unit configured to determine at least one item for sale at the store associated with the selected recipe; and
an output unit configured to generate a first output including the selected recipe and a second output that encodes the at least one item for sale at the store that is determined to be associated with the selected recipe.

2. The product promoting system according to claim 1, wherein
the item for sale associated with the recipe is a food item that is included in the recipe.

3. The product promoting system according to claim 1, wherein
the storage unit stores, in association with each of the recipes, data indicating the number of times said each of the recipes has been selected through the user input.

4. The product promoting system according to claim 1, wherein
the storage unit stores, in association with each of the recipes, data indicating the number of times said each of the recipes has been output to the user.

5. The product promoting system according to claim 1, wherein
the output unit includes a printing unit located at the store and configured to print the selected recipe.

6. The product promoting system according to claim 5, wherein
the printing unit is further configured to print an identification code of the recipe alongside the selected recipe.

7. The product promoting system according to claim 5, wherein
the printing unit is further configured to print an image indicating a coupon for the at least one item for sale at the store determined to be associated with the selected recipe alongside the selected recipe.

8. The information providing system according to claim 5, wherein
the output unit is further configured to write data related to the selected recipe in an RFID tag, which is attached to the printed recipe.

9. A method of generating an encoded output to be read by a point-of-sale (POS) system in response to a recipe selected by a user, comprising:
storing data of one or more recipes, each of the one or more recipes being stored in association with at least one item for sale at a store;
receiving a user input that selects a recipe from the one or more recipes;
determining at least one item for sale at the store associated with the selected recipe; and
generating a first output including the selected recipe and a second output that encodes the at least one item for sale at the store that is determined to be associated with the selected recipe, for decoding by a POS system at the store.

10. The method according to claim 9, wherein
the item for sale associated with the recipe is a food item that is included in the recipe.

11. The method according to claim 9, further comprising:
storing, in association with each of the recipes, data indicating the number of times said each of the recipes has been selected through the user input.

12. The method according to claim 9, further comprising:
storing, in association with each of the recipes, data indicating the number of times said each of the recipes has been output to the user.

13. The method according to claim 9, wherein
the generating the first output includes printing the selected recipe at the store.

14. The method according to claim 13, further comprising:
the generating the first output includes printing an identification code of the recipe alongside the selected recipe.

15. The method according to claim 13, further comprising:
the generating the second output includes printing an image indicating a coupon for the at least one item for sale at the store determined to be associated with the selected recipe alongside the selected recipe.

16. The method according to claim 13, further comprising:
writing data related to the selected recipe in an RFID tag, which is attached to the printed recipe.

17. A non-transitory computer readable medium comprising a program that is executable in a computing device to cause the computing device to perform a method of generating an encoded output to be read by a point-of-sale (POS) system in response to a recipe selected by a user, the method comprising:
storing data of one or more recipes, each of the one or more recipes being stored in association with at least one item for sale at a store;
receiving a user input that selects a recipe from the one or more recipes;
determining at least one item for sale at the store associated with the selected recipe; and
generating a first output including the selected recipe and a second output that encodes the at least one item for sale at the store that is determined to be associated with the selected recipe, for decoding by a POS system at the store.

18. The non-transitory computer readable medium according to claim 17, wherein
the item for sale associated with the recipe is a food item that is included in the recipe.

19. The non-transitory computer readable medium according to claim 17, wherein the method further comprises:
storing, in association with each of the recipes, data indicating the number of times said each of the recipes has been selected through the user input.

20. The non-transitory computer readable medium according to claim 17, wherein the method further comprises:
storing, in association with each of the recipes, data indicating the number of times said each of the recipes has been output to the user.
